(19) United States
(12) Patent Application Publication
(10) Pub. No.: US 2008/0013965 A1
(43) Pub. Date: Jan. 17, 2008

(54) Universal housing for microchips used in printer cartridges

(75) Inventor: Jason E. Hite, Cary, NC (US)

Correspondence Address: WILLIAM L. LONDON, 3010 LEE AVENUE, P.O. BOX 152, SANFORD, NC, 27330, US

(73) Assignee: Static Control Components, Inc., Sanford, NC (US)

(21) Appl. No.: 11/487,650

(22) Filed: Jul. 17, 2006

(51) Int. Cl. G03G 15/00

(52) U.S. Cl. 399/12

(57) ABSTRACT

The invention discloses a universal housing (413) for microchips used in imaging cartridges of printer machines with radially extended breakable part(s) (414, 415, 416) molded with said housing that breaks at one or more breakable joints, wherein said housing is sized to fit into the slot of a first imaging cartridge by retaining the extended molded part intact and to fit into the slot of one or more imaging cartridges with slot size(s) smaller in dimension compared to the slot size of said first imaging cartridge to hold the chip by breaking the extended molded part at said breakable joints to match the slot.

### FIELD OF THE INVENTION

The present invention relates to a housing for microchips used in the process cartridges or toner tubes of monochrome and color laser printers, and more particularly to universal housing for such microchips adapted to fit into the slots of process cartridges or toner tubes that differ in their physical dimensions.

### BACKGROUND OF THE RELATED ART

Imaging machines like monochrome laser printers and color laser printers are provided with toner cartridges or toner tubes that supplies the toners for the printing process. These toner cartridges or toner tubes are equipped with microchips with data and possibly embedded software programs designed to estimate the level of toner remaining within the cartridges or tubes. In some cases these microchips are also embedded with authentication programs to authorize use of the cartridge as per OEM's specification. These microchips are typically memory devices, micro controllers, or custom ASIC (Application Specific Integrated Circuit) with memories to perform their functions. The chips may use radio frequency (RF) to communicate with the printers including the Printer Engine Program (PEP) that controls the printer operations. To facilitate easy mounting of the chips onto the process cartridge or toner tube, it is sometimes modularized so as to be easily assembled.

It is well known that monochrome laser printers like Xerox Phaser 4500 and Xerox Phaser 5400 utilize a radio frequency (RF) chip to communicate with the printer.

Similarly color laser printers like Fuji Xerox C525A and Fuji Xerox C2535A and their equivalents are equipped with RF chips in the four-color toner tubes that are used in them.

The microchips, which may have a RAM or ROM or both types of memories, need a casing or housing to protect them from environment, mechanical shocks and static electricity. These casings are made into dimensions or sizes that fit into appropriate slots of the respective process cartridges or toner tubes for which they are made.

The dimension of the casings holding the chips is changed depending on the slot sizes of the process cartridge or toner tubes of the monochrome or color laser printers to accommodate the chips. This difference in size warrants manufacture of casings or dedicated housing of different physical dimensions to match the dimensions of the respective slots to fit in the chips with a need for carrying separate inventories for them for use in the assembly line thereby increasing both manufacturing and inventory costs. This is despite the fact that the functioning of the chips are not dependent on such critical dimensions of the housing so long it is close enough to transmit and receive the radio signals to and from the printer.

The present invention aims to solve this problem by providing a universal housing to contain the microchips that may be adapted for use in the process cartridges or toner tubes of different monochrome or color laser printers despite the variations in the dimensions of their slots to accommodate the chips. The present invention thus helps in considerable savings of the manufacturing and inventory costs for housing of microchips of process cartridges and toner tubes.

### SUMMARY OF THE INVENTION

The present invention accordingly provides a universal housing for microchips used in imaging cartridges of printer machines with radially extended breakable part(s) molded with said housing that breaks at one or more breakable joints, wherein said housing is sized to fit into the slot of a first imaging cartridge by retaining the extended molded part intact and to fit into the slot of one or more imaging cartridges with slot size(s) smaller in dimension compared to the slot size of said first imaging cartridge to hold the chip by breaking the extended molded part(s) at said breakable joints to match the slot.

The present invention further provides a universal housing for microchips used in process cartridges or toner tubes of laser printers adapted to fit into the slots of different dimensions in the cartridges or tubes for holding the chip comprising:
a top plate and
a bottom plate that press fits with the top plate to securely house the chip,
   wherein said top or bottom plate has a core with a core diameter matching the inside diameter of the slot for holding the chip in a first process cartridge or toner tube having the least slot size or inside diameter compared to slots of other cartridges and/or tubes for which the housing is designed, said core of the top or bottom plate having an extended part molded with it extending radially from the core and adapted to break manually through breakable joints just on the core periphery and at pre-determined radial distance(s) away from the core through one or more sets of breakable joints,
   such that the effective outside diameter of the housing assembly with top and bottom plates including the breakable extended part(s) in one of the plates at different points away from the core matches the inside diameter(s) of the slot(s) for holding the chip in process cartridge(s) or toner tube(s) having slot(s) larger than the corresponding slot in the first process cartridge or toner tube and the effective outside diameter of the housing assembly with top and bottom plates matches the inside diameter of the slot of first process cartridge or toner tube when the breakable extended part is entirely removed from the top or bottom plate, as the case may be.

Preferably, the breakable extensions are in the form of radially extending fins or annular disc(s) molded with the core of the top or bottom plate with breakable tab(s) or notches to facilitate manual breaking of the fins or disc(s) at different radial distance away from the core.

Preferably, the extended molded part with breakable joints is provided in the bottom plate of the housing assembly.

In one embodiment of the invention, a universal housing is provided for the microchips of two process cartridges or toner tubes with slots having internal diameters (IDs) of d1 and d2 (d2>d1) for mounting the chips wherein the top or bottom plate of the housing has a core diameter of d1 with fins or an annular disc radially extending from the core up to a radial distance d2/2 from the center of said plate and with manually breakable joints to break the fins or disc from the core.

In another embodiment of the invention, a universal housing is provided for the microchips of three process cartridges or toner tubes with slots having internal diameters (IDs) of d1 d2 and d3, respectively (d3>d2>d1) for mounting the chips, wherein the top or bottom plate of the housing has a core diameter of d1 with fins or annular disc(s) radially extending from the core up to a radial distance d3/2 from the center of said plate and with manually breakable joints to break the fins or discs from the core or away from the core at a radial distance of d2/2 from the center of said plate.

### BRIEF DESCRIPTION OF THE DRAWINGS

The invention is described with reference to the accompanying drawings, of which:

FIGS. 1a, 1b and 1c show the perspective and plan views of cartridge chip housing assembly for a conventional Xerox 4500 printer.

FIGS. 2a, 2b and 2c show the perspective and plan views of cartridge chip housing assembly for a conventional Xerox 5400 printer.

FIGS. 3a and 3b show the perspective views of toner tube chip housing assembly for a conventional color laser printer with the top and bottom plates of the housing in open and assembled position.

FIGS. 4a, 4b and 4c show the perspective and plan views of cartridge chip housing of a conventional Xerox 4500 printer incorporating the improvement made in the prior art in providing claws to the bottom plate to securely hold the chip to the cartridge.

FIGS. 5a, 5b and 5c show the perspective, plan and sectional views of the cartridge chip housing assembly and hopper cap of a conventional Xerox 5400 printer.

FIGS. 6a, 6b, 6c, 6d and 6e show perspective views of the top and bottom plates in separated and assembled positions and sectional views of the universal chip housing according to a first embodiment of the invention adapted for use in two printer cartridges with different slot sizes for example, with both Xerox 5400 and Xerox 4500 printer cartridges.

FIGS. 7a, 7b, 7c and 7d show perspective, plan and sectional views of the universal chip housing according to a second embodiment of the invention adapted for use in a printer cartridge or in a toner tube with different slot sizes for example, with both Xerox 4500 printer cartridge and color laser printer toner tubes.

FIGS. 8a and 8b show perspective view and side elevation of a universal chip housing with breakable fins according to a third embodiment of the invention adapted for use with printer cartridges/toner tubes having three different critical dimensions or slot IDs for example Xerox 5400, Xerox 4500 and color laser printers.

FIGS. 9a, 9b and 9c show the plan and sectional views of the universal chip housing according to aforesaid third embodiment showing preferable bottom plate dimensions and notch angles to break the fins at two different points away from the core.

FIGS. 10a and 10b show perspective and plan views of a universal chip housing with breakable discs according to a fourth embodiment of the invention adapted for use in the printer cartridges or tubes having three different critical dimensions (IDs) of the slots to hold the chip, for example Xerox 5400, Xerox 4500 and color chips.

### DETAILED DESCRIPTION OF THE INVENTION

In the description that follows the term “chip” has been used synonymously with the term “microchip” to mean the memory chips, micro controller chips or other electronic chips, possibly mounted on a printed circuit board with other components, that are used in the process cartridges or toner tubes of the monochrome laser printers or color laser printers.

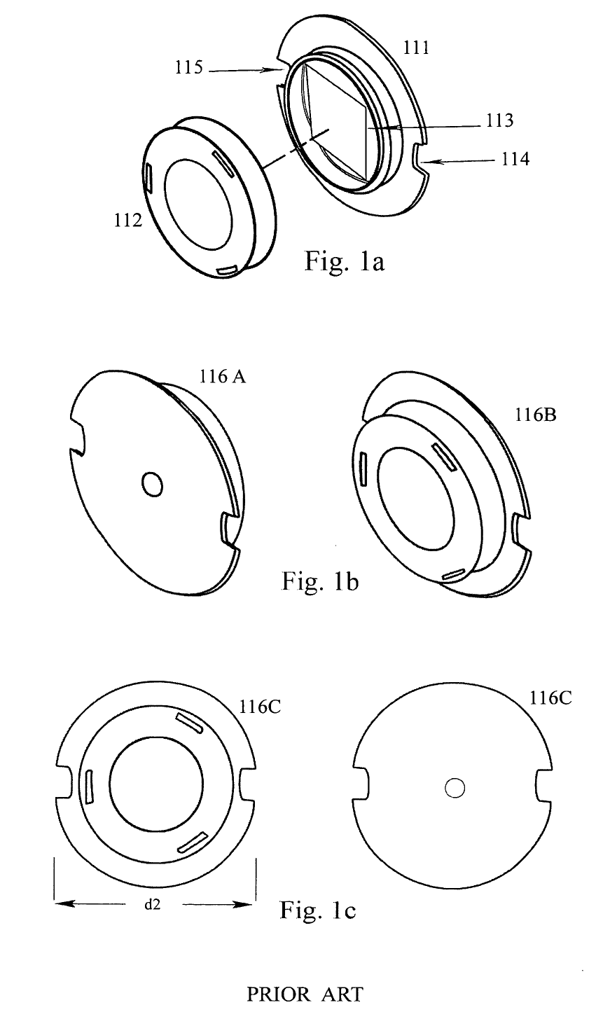

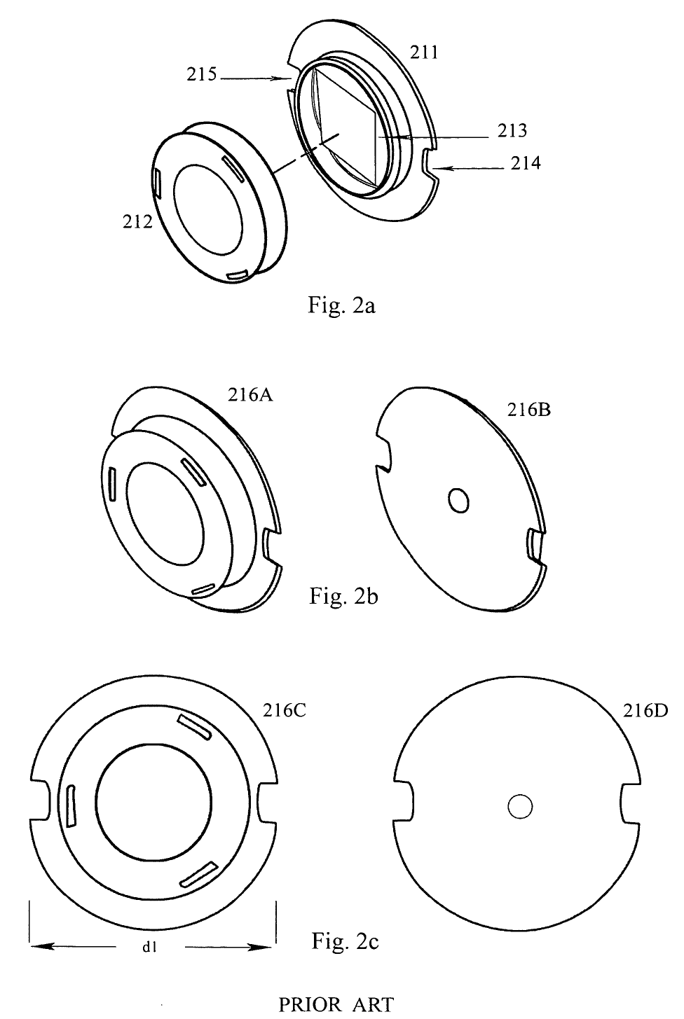

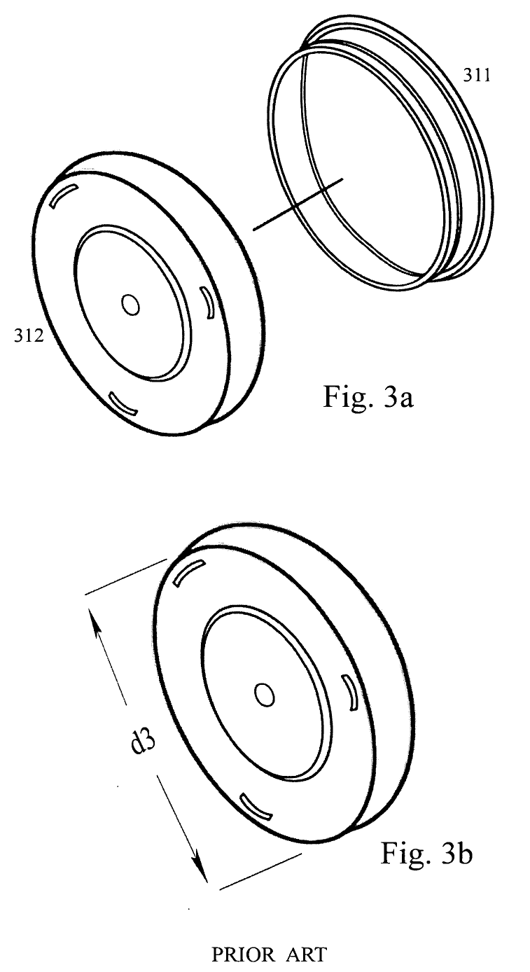

The conventional housing assembly for a Xerox 4500 chip (FIGS. 1a, 1b and 1c), Xerox 5400 chip (FIGS. 2a, 2b and 2c) for monochrome laser printers and color chip (FIGS. 3a and 3b) for color laser printers varies in their outside diameter (OD) to match the respective slots of process cartridges or toner tubes of the printers into which the chips are accommodated.

FIG. 1a shows the top plate (111) and bottom plate (112) of a conventional housing assembly of Xerox 4500 chip in an open position. An electronic device (113) as shown comprises the circuits constituting the chip proper with embedded software and memories along with an antenna such as an antenna coil fitted into the top assembly so as to face the rear face of bottom assembly (not shown in the figure). The top assembly of the housing has two pry slots 114 and 115 that enables the remanufacturers to remove the chip off the cartridge easily.

FIGS. 1b and 1c show the isometric views (116A and 116B) and plan views (116C and 116D), respectively of the housing assembly with an effective OD d2 of 1.172″ to match the slot ID of 1.178″ of a Xerox 4500 process cartridge.

FIG. 2a shows the top plate (211) and bottom plate (212) of a conventional housing assembly of Xerox 5400 chip in an open position. An electronic device (213) as shown comprises the circuits constituting the chip proper with embedded software, memories and antenna fitted in the top assembly so as to face the rear face of bottom assembly (not shown in the figure). The top assembly of the housing has two pry slots 214 and 215 that enables the remanufacturers to remove the chip off the cartridge easily.

FIGS. 2b and 2c show the isometric views (216A and 216B) and plan views (216C and 216D), respectively of the housing assembly with an effective OD d1 of 1.328″ to match the slot ID of 1.335″ of a Xerox 5400 process cartridge.

As can be seen from FIGS. 1a and 2a, there is hardly any difference in the dimensions of the electronic device (113, 213) which constitutes the Xerox 4500 and Xerox 5400 chips.

FIGS. 3a and 3b show conventional housing for chips used in toner tubes of color laser printers in open and assembled position, respectively. The assembly has an effective outside diameter d3 of 0.900″ to match the slot ID 0.907″ of toner tubes of color printers.

In the conventional housings for process cartridges or toner tubes as just described the top plate is usually sized to attain the effective OD of the housing.

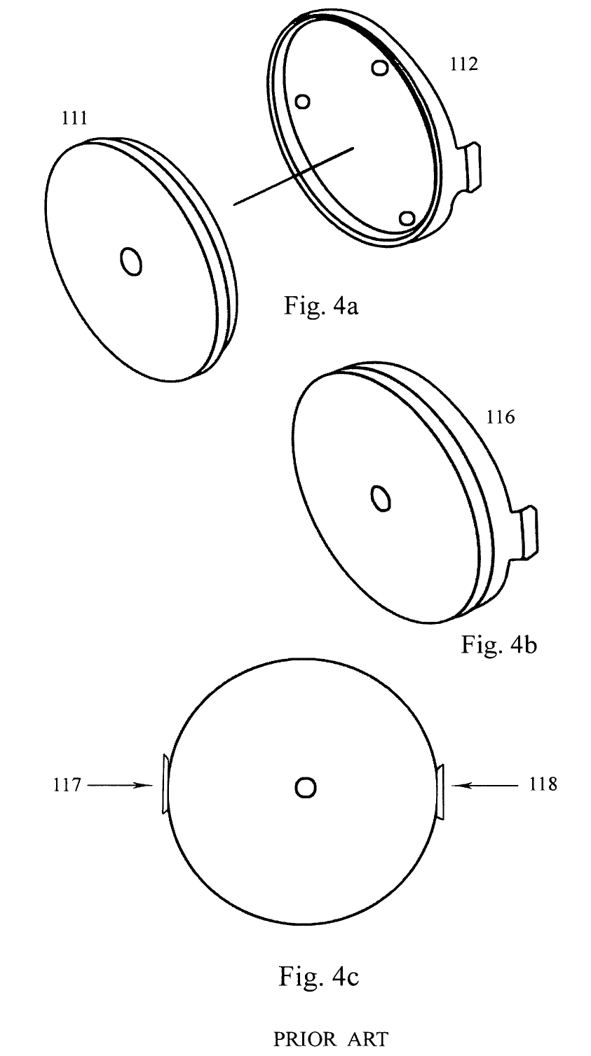

United States patent application with publication No. US 2004/0120724 A1 discloses an improved housing for a Xerox 4500 chip that fits into a process cartridge unit, and an image forming apparatus or the like having such a cartridge unit. The chip is housed in a mold that snaps into the side of the cartridge unit. The application also describes how information such as the amount of toner remaining in the hopper is stored. According to the improvement as disclosed in this application, in the Xerox 4500 chip housing assembly (116) with top plate (111) and bottom plate (112), as shown in FIGS. 4a, 4b and 4c, two elastic protruding claws (117 and 118) are disposed on the peripheral edge of the bottom plate (112) which helps to snap-fit the chip housing into the side of the cartridge unit and impede any unauthorized removal of the chip.

The critical dimension for the chip housing of an OEM Xerox 4500 process cartridge is the ID 1.178″ of slot of the cartridge that holds the chip. The effective OD of the remanufactured chip housing for this cartridge are made marginally shorter than this critical dimension for the required play in the mounting process. As illustrated in FIG. 1c, the effective OD (d2) of the housing is 1.172″, which is slightly smaller with reference to said critical dimension by 0.006″ to securely fit the chip inside the OEM slot on the side of the cartridge unit.

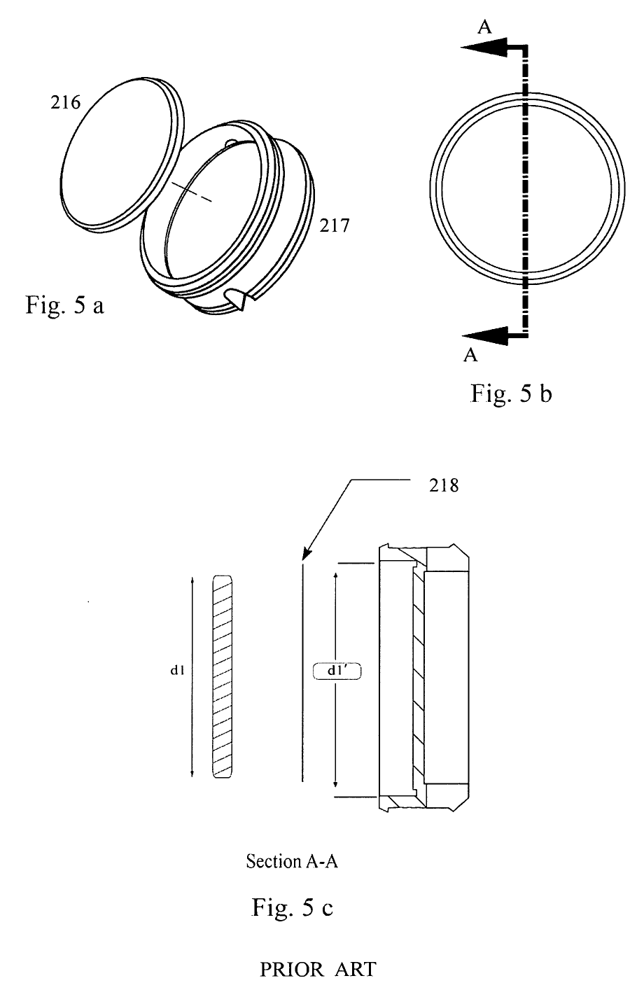

Another chip housing of process cartridges presently available is for Xerox Phaser 5400 printer where the chip housing assembly (216) is fitted inside the cartridge's hopper cap (217), as shown in FIGS. 5a, 5b and 5c. FIG. 5a illustrates an exploded view of the conventional Xerox 5400 chip housing showing the Xerox 5400 hopper cap (217) and Xerox 5400 chip housing (216). FIG. 5b illustrates a plan view of an assembly of the two, namely the hopper cap (217) and the chip housing (216) with an effective OD of d1=1.328″ which is marginally shorter by 0.007″ from the critical dimension that is ID of hopper cap (d1′=1.335″) to which it is mounted. FIG. 5c shows the sectional view of the assembly of the chip housing and the hopper cap of the Xerox 5400 chip having the critical internal diameter (ID) of 1.335″, which is critical to securely fit the chip (216) inside the OEM hopper cap (217). The 5400 chip is held on to the hopper cap by a circular strip of adhesive (218) provided at the back of the 5400 chip housing, preferably 0.003″ thick, which helps in affixing or securing the chip housing (216) onto the hopper cap (217) of the Xerox Phaser 5400 cartridge unit, so that the chip does not fall off during printing or transfer.

Although, both the Xerox Phaser 4500 and Xerox Phaser 5400 have similar designs for their cartridge chip housing, there are some differences in the mold apart from differences in the chip's functionality. The difference between the two chip housings lies in the effective outer diameter of the housings as mentioned before to match the critical dimensions of the slots IDs into which they are mounted. The dimension of chip housings is not critical to the functionality of the chips housed within it, but only to ensure proper fitting of the chips into the cartridge units by matching with the critical dimensions of the respective slots. As long as the chip is located in the radio frequency range of the printer, so that it can communicate, the chip will perform satisfactorily.

With the critical dimensions/diameters of the Xerox 4500 chip housing and the Xerox 5400 chip housing already established, one way to make a universal housing for chips of both the Xerox Phaser 4500 and Xerox Phaser 5400 would be to make a housing with breakable fins or disc(s) that extends up to the greater of the two diameters so that the user can break off the disc or tabs in the fin(s) if he wants to use the housing for the Xerox 4500 chip with a smaller slot or leave them on if he wants to use it for the Xerox 5400 chip with a larger slot in the hopper cap into which the chip is fitted. Accordingly, the universal housing for chips, according to the invention, aims to take care of the difference in the critical dimensions of the chip slots through a special mold design for the universal housing cover so that the top or bottom plate of the housing that fits with the respective bottom or top plate, as the case may be, has a core outer diameter of 1.172″ matching the internal diameter(1.178″) of the slot of OEM 4500 process cartridge with radially extending and breakable fins or disc by which the effective outer diameter of the housing cover including the fins or annular disc is increased to 1.328″ so as to fit into the slot having the ID (1.335″) of the hopper cap of OEM 5400 process cartridge. With such fins or disc(s) which are breakable in nature, the chip housing can be securely inserted either into a 4500 OEM cartridge by breaking the fins or disc before insertion or securely affixed to the hopper cap of 5400 OEM cartridge by retaining the fins or disc.

In the description that follows different embodiments of the invention have been described with reference to the illustrative drawings. For illustrative purpose only the bottom plate has been chosen for matching the critical dimension of the slots of process cartridges or toner tubes. However, it is made clear that top and bottom plate may be interchangeably used for manufacture of universal chip housing of the invention with its effective dimension matching the slots of the cartridges or tubes to which it is mounted.

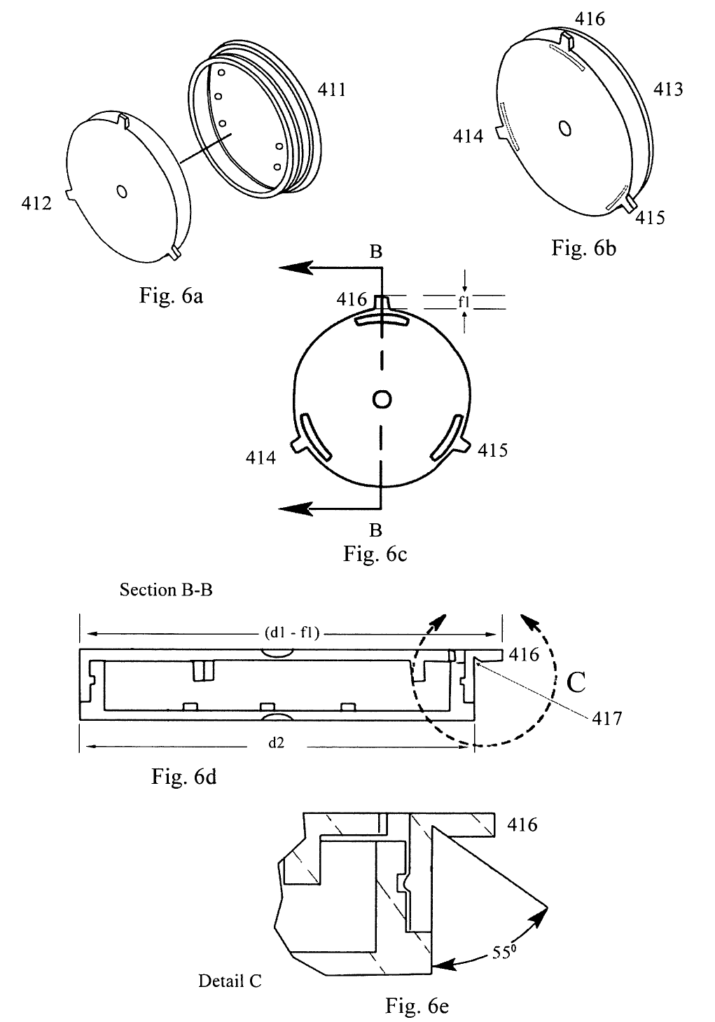

FIGS. 6a through 6e show a prototype design of a universal housing adapted for use with Xerox 5400 and Xerox 4500 chips, according to a first embodiment of the invention, comprising the top plate (411), bottom plate (412) and three fins (414, 415, 416) each having one breakable tab or notch (417) at a predetermined radial distance of f1=[(1.328″−1.172″)/2] or 0.078″ away from the core of the bottom or base plate, in order to convert from Xerox 5400 chip housing to Xerox 4500 chip housing by breaking the tabs at the breakable joints. FIGS. 6a and 6b illustrate perspective views of the top plate (411) and bottom plates (412) of the said universal housing in open and assembled positions, respectively. FIG. 6c illustrates a plan view of the said universal housing while FIG. 6d shows a sectional view of FIG. 6C through BB in the drawings. FIG. 6e illustrates a detailed diagram of a portion (C) of the sectional view of FIG. 6d showing the breakable extended part of the housing along with the angle of the notch (417). Preferably, the break off tab or notch (417) in each fins are provided at an angle of 55°, as shown in FIG. 6e.

A universal housing assembly for chips of Xerox Phaser 4500 and Xerox Phaser 5400, also benefits other printers with similarly dimensioned slots for accommodating process cartridge chips. For example, the equivalent of Xerox phaser 4500 viz, Brother HL-8050, Epson EPLN-3000 and Okidata B-6200/B-6300, Tally Genicom T9035, Fuji-Xerox 240A/340A, all use a 1.172″ outer diameter chip for their process cartridges. Similarly, the equivalent of Xerox phaser 5400 viz, Fuji-Xerox Docuprint 360A uses a 1.328″ outer diameter chip in its process cartridge.

The concept of the invention can be extended to chips for other laser printers where the slots of the process cartridges or toner tubes for holding the chips have critical dimensions (internal diameters) other than that mentioned for the Xerox Phaser 4500 and Xerox Phaser 5400 or other printers of the same family as described above. One such other chip can be a chip for a color laser printer that needs a smaller core outer diameter of 0.900″ for the chip housing assembly, while the slot ID of the toner tube is 0.907″. Additionally, the techniques of the present invention are applicable to any type of chip housing which is sized for attachment to a first type of toner cartridge and where a portion of the chip housing is removed to form a modified chip housing sized for attachment to a second type of toner cartridge.

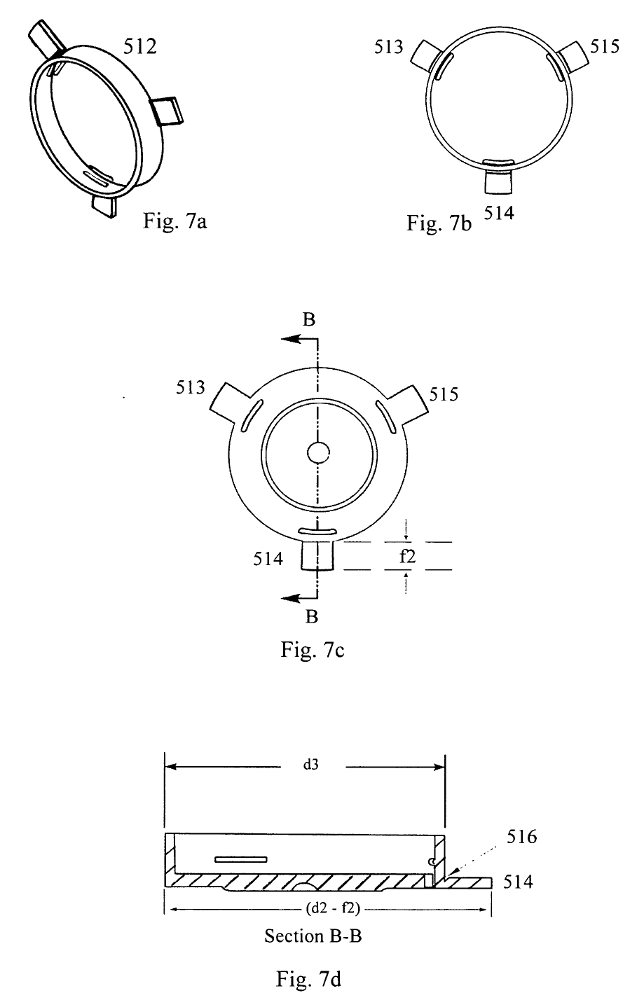

FIGS. 7a through 7d show a prototype design for bottom plate (512) with breakable fins (513, 514, 515) adapted for use in Xerox 4500 and color chips, according to a second embodiment of the invention. FIGS. 7a, 7b and 7c show perspective, rear and front views, respectively, of the bottom plate (512) with the extended fins. FIG. 7d is a sectional view through BB of FIG. 7c. The bottom plate (512) has a core diameter (d3) of 0.900″ to match the ID (0.907″) of toner tube of color printer and the three fins are extended from the core to a radial distance of f2=[(1.172″−0.900″)/2] or 0.136″ away from the core to have an effective OD (d2) of 1.172″ to match the slot ID (1.178″) of Xerox 4500 process cartridge. Fins are provided with notches (516) to break them off the core of the bottom plate (512), as shown in FIG. 7d.

The color chips that can be included for such extended version of the universal housing are, for example,
a). Fuji-Xerox C525A (base engine) and its equivalent, eg.
   i) Dell 3000cn;
   ii) Dell 3100cn;
   iii) Epson AcuLaser C1100 and
   iv) Epson LP-V500.
b). Fuji-Xerox C2535A (base engine) and its equivalent, eg.
   i) Brother HL-4200cn;
   ii) Dell 5100cn;
   iii) Epson AcuLaser C4100;
   iv) Epson AcuLaser C4200;
   v) Konica Minolta 3300;
   vi) Tally Genicom T8024;
   vii) Xerox Phaser 6300 and
   viii) Xerox Phaser 6350.

All these color printers have four color toner tubes, each with a smaller circular chip. The conventional color chips from the printers listed above may also utilize the elastic claw feature, similar to the conventional Xerox 4500 chip, to snap fit each chip into the side of the toner tube.

The concept of universal housing for two dimensionally different chips like Xerox 5400 and Xerox 4500 chip or Xerox 4500 and color chip as described above may be further extended to three dimensionally different chips like a Xerox 5400 chip, or Xerox 4500 chip and a color chip with slot IDs or critical dimensions of 1.335″, 1.178″ and 0.907″ respectively.

The smaller diameter chips of color laser printers can be included to the universal housing for memory chips of process cartridges of Xerox Phaser 4500 and Xerox Phaser 5400 monochrome laser printers by use of a molded top or bottom plate with extended fins or disc breaking manually at the core and at a second point away from the core matching the diameter of the Xerox 4500 chip having a critical OD between a Xerox 5400 chip and a color chip.

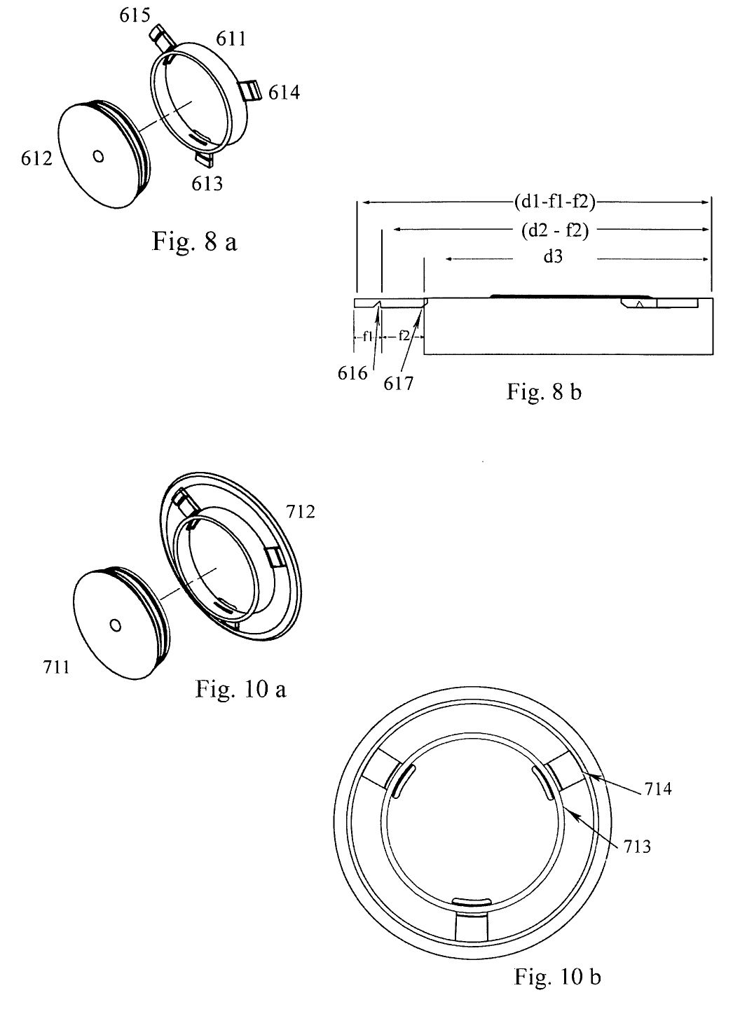

FIGS. 8 through 10 illustrate arrangements that provide quick and easy adaptation of the universal housing for process cartridges and toner tubes, according to the present invention, with three different critical dimensions or slot IDs to hold the chip. This is achieved by having fins and/or discs with plurality of breakable joints at different points extending radially that matches the critical dimensions or slot IDs of printer cartridges and or tubes.

FIG. 8a shows the perspective view of the bottom plate (611) and top plate (612) of the chip housing, with extended breakable fins (613, 614, 615) on the bottom plate (611), according to a third embodiment of the invention, adapted for use with Xerox 5400, Xerox 4500 and color chips having three different critical dimensions or IDs of the respective slots to hold the chip. FIG. 8b gives a side elevation of the housing assembly for this embodiment that shows a first notch (616) at the core of the bottom plate and a second notch (617) away from the core on the extended fin to enable the user to easily break the fins at the notches to match the ID of the cartridge or tube in which the chip is mounted. The core of the bottom plate has an OD of 0.900″ (d3). The effective OD of the housing with the extended fins up to the second notch is 0.172″ (d2) and the effective OD of the housing up to the end of the fins is 1.328″ (d1). Accordingly, by keeping the fins intact the OD of the housing 1.328″ matches the ID (1.335″) of a Xerox 5400 hopper cap into which the chip is mounted. By breaking the fins at the second notch (617), the effective OD of the housing 1.172″ matches the slot ID (1.178″) of Xerox 4500 cartridge and by breaking the fins at the first notch (616), the fins are removed entirely from the bottom plate leaving the core resulting in an effective OD of 0.900″ for the housing matching the slot ID of 0.907″ for holding the color chip.

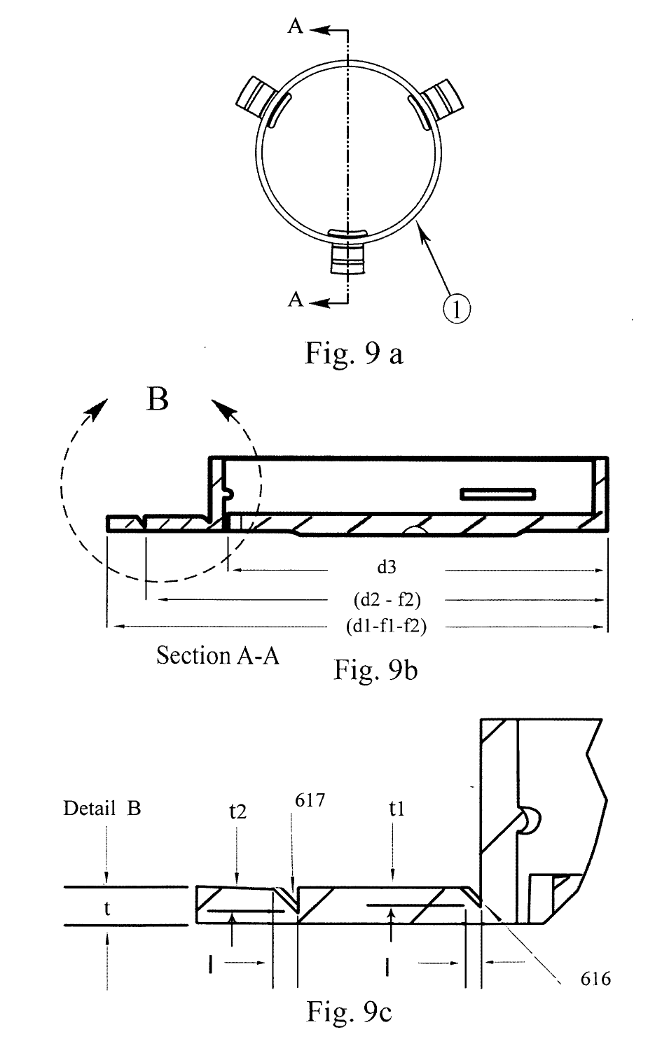

The breaking tab(s) or notch(es) is/are provided on the disc(s) or fins at certain angles to the main body of the housing cover to facilitate manual breaking of the fins or disc(s). FIGS. 9a and 9b show the plan and sectional views, respectively, of the universal housing according to the aforesaid third embodiment, while FIG. 9c illustrates a detailed diagram of a portion (B) of the said sectional view of FIG. 9b showing the critical or preferred dimensions/angles of break off tabs in the fins which are attached to the bottom plate of the universal housing, that allows for easy manual breaking with minimal damage or leftover mold fragments. In the preferred embodiment as shown in FIG. 9c, the thickness of each of the fins has been taken as t=0.030″. The notch (616) at the core periphery of the bottom plate and closer to the main body of the housing is preferably at a lower depth (t1=0.015″) than the one which is away from the main body of the housing cover (617) (t2=0.020″). Further, the notch (616) on the fins closer to the main body of the housing cover is preferably provided at an angle of 530 while the notch (617) on the fins away from the core of the housing cover is provided at an angle of 450. The notches preferably have equal lengths of 1=0.020″.

The breakable part or parts of the housing may be a plurality of breakable fins, as described above, or annular disc(s) affixed to the housing cover with breakable joints. FIGS. 10a and 10b show perspective and enlarged plan views, respectively, of a universal housing with breakable discs, according to a fourth embodiment of the invention, adapted for use with Xerox 5400, Xerox 4500 and color chips. The universal housing, as shown in FIG. 10a, has two main parts, namely, the bottom plate (711) and top plate (712) with break off annular discs. To use such universal housing for Xerox 5400 memory chip, no breaking of any disc is required. The effective diameter of the universal housing including both the annular discs is 1.328″ that matches the ID of hopper cap for OEM 5400 process cartridge. To use the said universal housing for Xerox 4500 chip, the outer disc is taken off by breaking at point 714, and to use the universal housing for color chips, the disc is broken at the point 713 so that the effective OD of the housing with one and no disc matches the slot Ids for Xerox 4500 process cartridge and color toner tube respectively.

The breakable material is designed in such a way so that the user can easily break off the tabs with their hands without the aid of tools. The base and top plates are preferably made from molded plastics like ABS plastic, LDPE, etc.

Presently, OEM process cartridges and toner tubes have circular slots to hold the memory chips. The universal housing according to the present invention can also be adapted for use in slots of other geometrical dimensions like a square or a polygon, if required.

### BENEFITS OF THE INVENTION

The invention provides the following benefits and advantages for the manufacturer:

The universal chip housing of the invention helps to rationalize the manufacturer's product line.

Producing one mold for two or three different applications can save production time and cost (cheaper tooling costs).

The manufacturer can modify each chip housing in-house and sell them as the corresponding chip housing without their customer knowing that the chips are universal.

Multiple cavity molds of one design allow for fast mass production of the chip housings that can be modified and used in two or three different applications.

The universal housing of the invention can be advantageously used both by original equipment manufacturers (OEM) and remanufacturers.

While the invention has been described with particular reference to the illustrated embodiments, it will be understood that numerous modifications thereto will appear to those skilled in the art. Accordingly, the above description and accompanying drawings should be taken as illustrative of the invention and not in a limiting sense.

What is claimed is:

1. A universal housing for microchips used in imaging cartridges of printer machines with radially extended breakable part(s) molded with said housing that breaks at one or more breakable joints, wherein said housing is sized to fit into the slot of a first imaging cartridge by retaining the extended molded part intact and to fit into the slot of one or more imaging cartridges with slot size(s) smaller in dimension compared to the slot size of said first imaging cartridge to hold the chip by breaking the extended molded part at said breakable joints to match the slot.

2. A universal housing for microchips used in process cartridges or toner tubes of laser printers adapted to fit into the slots of different dimensions in the cartridges or tubes for holding the chip comprising:
a top plate and
a bottom plate that press fits with the top plate to securely house the chip,
wherein said top or bottom plate has a core with a core diameter matching the inside diameter of the slot for holding the chip in a first process cartridge or toner tube having the least slot size or inside diameter compared to slots of other cartridges and/or tubes for which the housing is designed, said core of the top or bottom plate having an extended part molded with it extending radially from the core and adapted to break manually through breakable joints just on the core periphery and at pre-determined radial distance(s) away from the core through one or more sets of breakable joints,
such that the effective outside diameter of the housing assembly with top and bottom plates including the breakable extended part(s) in one of the plates at different points away from the core matches the inside diameter(s) of the slot(s) for holding the chip in process cartridge(s) or toner tube(s) having slot(s) larger than the corresponding slot in the first process cartridge or toner tube and the effective outside diameter of the housing assembly with top and bottom plates matches the inside diameter of the slot of first process cartridge or toner tube when the breakable extended part is entirely removed from the top or bottom plate, as the case may be.

3. The universal housing as claimed in claim 2, wherein the breakable extensions are in the form of radially extending fins or annular disc(s) molded with the core of the top or bottom plate with notches at the breaking points to facilitate manual breaking of the fins or disc(s) at different radial distance(s) away from the core.

4. The universal housing as claimed in claim 2, wherein said housing is for two process cartridges or toner tubes with slots having internal diameters (IDs) of d1 and d2 (d2>d1) for mounting the chips wherein the top or bottom plate has a core diameter of d1 with fins or an annular disc radially extending from the core up to a radial distance d2/2 from the center of the top or bottom plate, as the case may be, with manually breakable joints to break the fins or disc from the core.

5. The universal housing as claimed in claim 4, wherein said housing is for the chips of process cartridges of a first printer with a slot ID of 1.178″ to hold the chip and of a second printer with a slot ID of 1.335″.

6. The universal housing as claimed in claim 4, wherein said housing is for the chips of toner tubes of a color printer with a slot ID of 0.907″ to hold the chip and a process cartridge of a second printer with a slot ID of 1.178″.

7. The universal housing as claimed in claim 4, wherein the notches are provided at an angle of 55° at the breakable joints.

8. The universal housing as claimed in claim 5, wherein the notches are provided at an angle of 55° at the breakable joints.

9. The universal housing as claimed in claim 6, wherein the notches are provided at an angle of 55° at the breakable joints.

10. The universal housing as claimed in claim 1, wherein said housing is for three process cartridges or toner tubes with slots having internal diameters (IDs) of d1, d2 and d3 respectively (d3>d2>d1) for mounting the chips wherein the top or bottom plate has a core diameter of d1 with fins or annular disc(s) radially extending from the core up to a radial distance d3/2 from the center of the top or bottom plate, as the case may be, with manually breakable joints to break the fins or disc(s) from the core and away from the core at a radial distance of d2/2 from the center of said plate.

11. The universal housing as claimed in claim 10, wherein the angular notches are provided with a progressively higher depth at said predetermined breaking points away from the core.

12. The universal housing as claimed in claim 10, wherein the notches which are just on the core periphery and those which are at a radial distance of d2/2 from the center of the top or bottom plate are provided at an angle of 53° and 45°, respectively.

13. The universal housing as claimed in claim 2, wherein the assembly has an universal top plate and a bottom plate with breakable extended part(s) to match the slots of different dimensions in a plurality of process cartridges and/or toner tubes.

14. The universal housing as claimed in claim 2, wherein the assembly has an universal bottom plate and a top plate with breakable extended part(s) to match the slots of different dimensions in a plurality of process cartridges and/or toner tubes.

15. The universal housing as claimed in claim 3, wherein the breakable extensions are in the form of fins with at least three radially extending fins.

16. The universal housing as claimed in claim 2, wherein the effective outside diameters of the housing assembly are made marginally shorter than the inside diameters of the slots which hold them so as to have a minimum but necessary play for mounting the chip into the process cartridge or toner tube.

17. The universal housing as claimed in claim 16, wherein said play is about 0.006″ to about 0.007″.

18. A universal housing for holding a chip used in imaging cartridges comprising:
the universal housing adapted for holding the chip and sized for attachment to a first type of imaging cartridge, wherein a portion of the housing is removable to form a modified universal housing sized for attachment to a second type of imaging cartridge.

19. A method comprising:
providing a universal chip housing for holding a chip used in imaging cartridges, the universal chip housing sized for attachment to a first type of imaging cartridge and not sized for attachment to a second type of imaging cartridge;
removing a portion of the chip housing to form a modified chip housing sized for attachment to the second type of imaging cartridge.
